(19) United States
(12) Patent Application Publication
(10) Pub. No.: US 2020/0378803 A1
(43) Pub. Date: Dec. 3, 2020

(54) OPTICAL ENCODER

(71) Applicant: MITUTOYO CORPORATION, Kanagawa (JP)

(72) Inventor: Akihide KIMURA, Saitama (JP)

(73) Assignee: MITUTOYO CORPORATION, Kanagawa (JP)

(21) Appl. No.: 16/879,122

(22) Filed: May 20, 2020

(30) Foreign Application Priority Data
May 30, 2019 (JP) 2019-101143

(51) Int. Cl. G01D 5/347

(52) U.S. Cl. CPC G01D 5/34715; G01D 5/3473; G01D 5/34746

(57) ABSTRACT

The optical encoder includes a scale, a head moves relative to the scale, and a calculating unit performs calculation based on the relative movement. The head includes a light source and a receiving unit having a light receiving surface. The scale includes a step portion on a scale surface. The step portion generates interference light having a contrast pattern on the light receiving surface, and generate the darkest portion with the highest contrast in the contrast pattern. The light source irradiates the step portion with light in a direction inclined with respect to a direction perpendicular to the scale surface. The calculating unit includes an origin calculating unit that identifies the darkest portion from the contrast pattern and calculates the identified darkest portion as the origin position that is a reference of the relative movement between the scale and the head.

### CROSS-REFERENCE TO RELATED APPLICATION

This non-provisional application claims priority under 35 U.S.C. § 119(a) from Japanese Patent Application No. 2019-101143, filed on May 30, 2019, the entire contents of which are incorporated herein by reference.

### BACKGROUND

### Technical Field

The present invention relates to an origin detecting apparatus in a measuring instrument such as an optical encoder.

### Background Art

Conventionally, an optical encoder comprising a scale having a scale pattern provided along the measurement direction, a head that opposes to the scale and moves relative to the scale along the measurement direction, and a calculating unit for performing calculation based on the relative movement of the scale and the head. In this type of optical encoder, the head includes a light source for irradiating light to the scale, and a light receiving unit having a light receiving surface for receiving light from the light source through the scale.

The calculating unit in such an optical encoder detects the origin position from the scale, calculates the relative movement amount between the scale and the head based on the detected origin position.

As a detection method of the origin position, for example, there is a method according to the origin detecting device (optical encoder) described in Japanese Patent Application Laid-Open No. 10-2717.

The origin detecting device includes a light emitting element (light source) for irradiating parallel light beam through a collimator lens, a scale for passing parallel light beam in an arbitrary contrast pattern, a light receiving element (light receiving unit) for detecting the amount of the light passing through the scale. The scale includes a phase shifting layer formed of a transparent thin film, and a step that is an edge of the phase shifting layer. The light passing through the scale interferes at the step of the phase shifting layer, and forms the dark area where the amount of light detected by the light receiving element is in the lowest level in the contrast pattern received by the light receiving element, that is, the dark area with the highest contrast. The origin detecting device detects the position of this dark area with the highest contrast as the origin position.

Specifically, from the parallel light beam through the scale, a reference light beam transmitted through the portion without the phase shifting layer, and a phase-shifted light beam transmitted through the phase shifting layer, are generated. Since the phase-shifted light beam passes through the phase shifting layer having a refractive index different from that of the scale, the light speed of the phase-shifted light beam is slower than that of reference light beam. Therefore, a phase difference occurs between the reference light beam and the phase-shifted light beam. By this phase difference, the reference light beam and the phase-shifted light beam interfere by diffracting at the step, and generate the dark area with the highest contrast in the light receiving element immediately below the step. Here, the dark area is formed with the highest contrast when the phase difference between the reference light beam and the phase-shifted light beam is a half-wavelength λ/2 with respect to the wavelength A of the light of the light emitting element. Therefore, the thickness of the phase shifting layer is set so that the phase difference between the reference light beam and the phase-shifted light beam is half-wavelength λ/2.

The origin detecting device, first, causes the light emitting element to emit light to irradiate parallel light beam toward the scale, and causes the scale to move relative to the light emitting element and the light receiving element, in order to detect the dark area with the highest contrast as the origin position. Next, when the scale is moved, the parallel light beam is irradiated to the step. At this time, the light receiving element continues to observe the output level of the signal due to the received interference light. When parallel light beam is irradiated to the step, the light receiving element detects the dark area with the highest contrast. Since the origin detecting device detects this dark area with the highest contrast as the origin position, the origin detecting device can easily detect the origin position based on the phase shifting layer and the step.

### SUMMARY OF THE INVENTION

### Problems to be Solved by the Invention

Here, the contrast of the contrast pattern is varied by the phase difference between the reference light beam and the phase-shifted light beam (hereinafter, sometimes referred to as two light waves). Further, the phase difference of the two light waves is varied by the difference between the optical path length of the reference light beam and the optical path length of the phase-shifted light beam and the change in the wavelength of the light source. The origin detecting device described in Japanese Patent Application Laid-Open No. 10-2717 set the phase difference between the reference light beam and the phase shifted light beam to be a half-wavelength λ/2 by adjusting the thickness of the phase shifting layer, thereby the dark area with the highest contrast is formed.

However, even by adjusting the thickness of the phase shifting layer, the phase difference of the two light waves fluctuates due to, for example, the manufacturing error of the thickness of the phase shifting layer, the error of the refractive index of the scale material, deformation of the scale material due to environmental changes such as heat, and change in wavelength of the light of the light source. There is a problem that the fluctuation in the phase difference of the two light waves deteriorates the contrast of the contrast pattern, and thereby the detection accuracy of the origin position may be deteriorated.

An object of the present invention is to suppress the deterioration of the contrast due to the fluctuation of the phase difference, to provide an optical encoder capable of detecting the origin position with high accuracy.

### Means for Solving the Problems

The optical encoder of the present invention includes a scale having a scale pattern provided along the measurement direction, a head that opposes to the scale and moves relative to the scale along the measurement direction, and a calculating unit for performing a calculation based on the relative movement of the scale and the head. The head includes a light source for irradiating light to the scale, and a light receiving unit having a light receiving surface for receiving light from the light source through the scale. The Scale comprises a step portion formed as a step with a height difference in a scale surface facing at least one of the light source or the light receiving unit. The step portion generates interference light having a contrast pattern on the light receiving surface when light is irradiated from the light source, and generate the darkest portion with the highest contrast in the contrast pattern. The light source irradiates the step portion with light in a direction inclined with respect to a direction perpendicular to the scale surface. The calculating unit includes an origin calculating unit that identifies the darkest portion from the contrast pattern in the interference light received by the light receiving unit through the step portion and calculates the identified darkest portion as the origin position that is a reference of the relative movement between the scale and the head.

According to the present invention described above, by irradiating the step portion with light in a direction inclined with respect to a direction perpendicular to the scale surface, the light source in the optical encoder can reduce the influence on the phase difference between the two light waves, even if there are manufacturing errors in the thickness of the step, deformation of the scale due to environmental changes, changes in the wavelength of the light source, and the like. The origin calculating unit in the calculating unit identifies the darkest portion from the contrast pattern with high contrast caused by the interference light with suppressed fluctuation of the phase difference between the two light waves, and calculates the identified darkest portion as the origin position.

Therefore, the optical encoder can suppress the deterioration of the contrast due to the fluctuation of the phase difference, and detect the origin position with high accuracy.

At this time, the light source preferably irradiates the step portion with light in a direction inclined along a plane perpendicular to the measurement direction.

Here, in case the light source irradiates the step portion with light in a direction inclined with to an arbitrary direction, the position of the darkest portion generated at a position corresponding to the step portion may move depending on how the light is irradiated. If the position of the darkest portion moves, a deviation in the origin position calculated by the origin calculation unit may occur, and that may cause an error.

However, according to such a configuration, by irradiating the step portion with light in a direction inclined along a plane perpendicular to the measurement direction, the light source can suppress the movement of the position of the darkest portion, and cause the darkest portion at the position corresponding to the step portion. Therefore, the optical encoder can suppress the deviation of the origin position due to the irradiation angle of light to the step portion.

At this time, it is preferable that the step portion includes a lower portion provided at a low position in the scale surface, an upper portion provided at a high position in the scale surface, and a connection surface for connecting the lower portion and the upper portion. Further, it is preferable that the light source irradiates the step portion with light in a direction inclined along the connection surface.

According to such a configuration, by irradiating the step portion with light in the direction inclined along the connection surface, the light source can suppress the movement of the position of the darkest portion described above, and it is possible to easily design such as the arrangement of the light source that causes the darkest portion at a position corresponding to the step portion or the connection surface.

At this time, the connection surface is preferably formed in a plane perpendicular to the measurement direction.

According to such a configuration, by the connection surface being formed in a plane perpendicular to the measurement direction, the darkest portion can be in a narrower range. For example, if the step portion is formed in a stepped shape in the scale surface, the darkest portion is formed in a straight line at a position corresponding to the connection surface. Therefore, since the darkest portion formed at a position corresponding to the connection surface can be formed as a line or a point, the optical encoder can generate the origin position with high accuracy.

At this time, the step portion is preferably formed on the scale surface so that the contrast pattern is pseudo-random.

According to such a configuration, by the step portion being formed on the scale surface so that the contrast pattern is pseudo-random, the difference in the brightness of the contrast pattern in the light receiving unit can be made remarkable. Consequently, the optical encoder can detect the origin position with high accuracy and easily even if there is a cause of deterioration of the contrast due to the fluctuation of the phase difference.

At this time, the step portion preferably reflects the light from the light source toward the light receiving unit.

According to such a configuration, the thickness of the step portion can be reduced when the light from the light source is reflected toward the light receiving unit, as compared with the case where the step portion transmits the light from the light source. Therefore, the optical encoder can reduce the cost and miniaturize as compared with the case where the step portion transmits the light from the light source.

### BRIEF DESCRIPTION OF THE DRAWINGS

FIG. 1 is a perspective view illustrating an optical encoder according to the first embodiment.

FIG. 2 is a block diagram illustrating the optical encoder.

FIGS. 3A to 3C are schematic diagrams illustrating the optical encoder.

FIGS. 4A and 4B are graphs showing changes in phase difference between two light waves in the optical encoder.

FIG. 5 is a perspective view illustrating an optical encoder according to the second embodiment.

FIGS. 6A to 6C are schematic diagrams illustrating the optical encoder.

FIGS. 7A and 7B are schematic diagrams illustrating an optical encoder according to the third embodiment.

FIG. 8 is a perspective view illustrating an optical encoder according to the fourth embodiment.

### DETAILED DESCRIPTION OF THE EMBODIMENTS

### First Embodiment

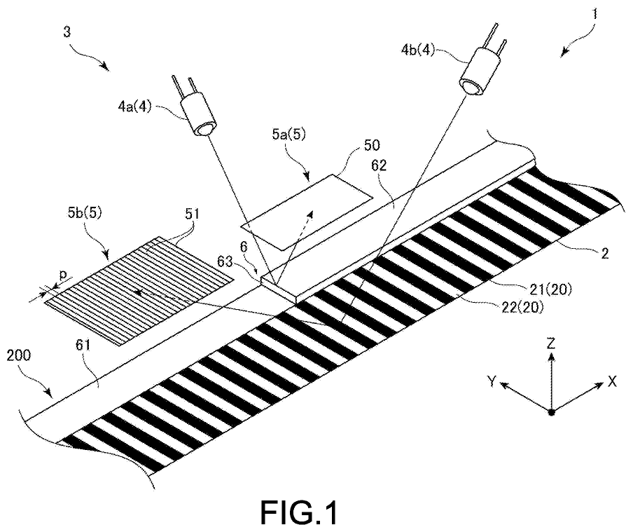

Hereinafter, a first embodiment of the present invention will be described with reference to FIGS. 1 to 4B.

In each of the drawings, the longitudinal direction of a scale 2 is shown as an X direction, the lateral direction is shown as a Y direction, and the height direction is shown as a Z direction. Hereinafter, these directions may be simply described as an X direction, a Y direction, and a Z direction.

FIG. 1 is a perspective view illustrating an optical encoder 1 according to the first embodiment.

As shown in FIG. 1, the optical encoder 1 includes an elongated scale 2, a head 3 that opposes to the scale 2 and moves relative to the scale 2 along the X direction that is a measurement direction.

The optical encoder 1 is a linear encoder used for a linear scale which is a measuring device (not shown). The optical encoder 1 is provided inside the linear scale. The linear scale detects the position of the head 3 with respect to the scale 2 by relatively moving the head 3 with respect to the scale 2 along the X direction which is the measurement direction, and outputs the detection result to a display such as a liquid crystal display (not shown).

The head 3 includes a light source 4 for irradiating light to the scale 2, a light receiving unit 5 having a light receiving surface 50 for receiving light from the light source 4 through the scale 2. The head 3 is provided to be able to advance and retreat in the X direction with respect to the scale 2.

The scale 2 is, for example, formed of glass or the like. On one surface of the scale 2, a scale pattern 20 is provided along the X direction which is the measurement direction.

The scale pattern 20 is a reflective type that reflects light from the light source 4. The scale pattern 20 has reflecting portions 21 for reflecting light from the light source 4 and non-reflecting portions 22 that does not reflect light. The scale pattern 20 is a so-called incremental pattern in which reflective portions 21 and non-reflective portions 22 are alternately arranged at a predetermined pitch along the X direction. From the light through the incremental pattern, a sinusoidal signal, which is an incremental signal, is generated. The optical encoder 1 calculates the relative movement amount between the scale 2 and the head 3 by analyzing the sinusoidal signal.

The scale 2 is provided with a step portion 6 formed as a step with a height difference in the scale surface 200 facing the light source 4 and the light receiving unit 5.

The step portion 6 is provided side by side with the scale pattern 20. The step portion 6 includes a lower portion 61 provided at a low position in the scale surface 200, an upper portion 62 provided at a high position in the scale surface 200, a connection surface 63 for connecting the lower portion 61 and the upper portion 62. The connection surface 63 is formed in a plane perpendicular to the X direction that is the measurement direction. That is, in the present embodiment, the connection surface is formed in the Y-Z plane. The scale pattern 20 and the step portion 6 reflect the light from the light source toward the light receiving unit 5.

When the light is irradiated by the light source 4, the step portion 6 generates interference light causing a contrast pattern on the light receiving surface 50 of the light receiving unit 5 and generates a darkest portion (not shown) which is the darkest pattern in the contrast pattern.

The light source 4 is, for example, a semiconductor laser for irradiating parallel light having a constant beam width. The light source 4 is provided at an appropriate angle for irradiating the light to scale 2. Note that the light source 4 is not limited to the semiconductor laser, it may be used any light source. Further, the light source 4 includes a light source 4a used for detecting the origin position and a light source 4b used for detecting the relative movement of the scale 2 and the head 3.

The light source 4a irradiates the step portion 6 with the light in a direction inclined with respect to a direction perpendicular to the scale surface 200. Specifically, the light source 4a irradiates the step portion 6 with the light in a direction inclined along the connection surface 63. That is, the light source 4a irradiates the light parallel to the Y-Z plane along the Y-Z plane, at an angle from the scale surface 200 or from a direction perpendicular to the scale surface 200.

The light source 4b irradiates the scale pattern 200 of the scale 2 with the light.

The light receiving unit 5 includes a light receiving unit 5a used for detecting the origin position, and a light receiving unit 5b used for detecting the relative movement of the scale 2 and the head 3. A PDA (Photo Diode Array) is used as the light receiving unit 5. The light receiving unit 5 are not limited to the PDA, and any light receiving device such as a PSD (Position Sensitive Detector) or a CCD (Charge-Coupled Device) may be used.

The light receiving unit 5a is provided at a position capable of receiving the light from the light source 4a through the scale 2. The light receiving unit 5b is provided at a position capable of receiving the light from the light source 4b through the scale pattern 20 of the scale 2. The light receiving unit 5b includes a plurality of light receiving elements 51 arranged at an arrangement pitch p along the X direction that is the measurement direction. The light receiving element 51 detects the relative movement amount between the scale 2 and the head 3 from the light through the scale pattern 20.

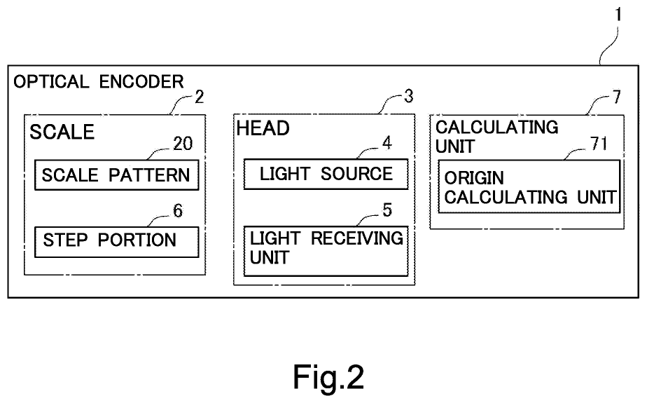

FIG. 2 is a block diagram illustrating the optical encoder 1.

As illustrated in FIG. 2, the optical encoder 1 includes a calculating unit 7 that performs calculation based on the relative movement of the scale 2 and the head 3. The calculating unit 7 is, for example, a microcomputer or the like.

The calculating unit 7 includes an origin calculating unit 71 that identifies the darkest portion from the contrast pattern in the interference light received by the light receiving unit 5a through the step portion 6 and calculates the identified darkest portion as the origin position that is a reference of the relative movement between the scale 2 and the head 3.

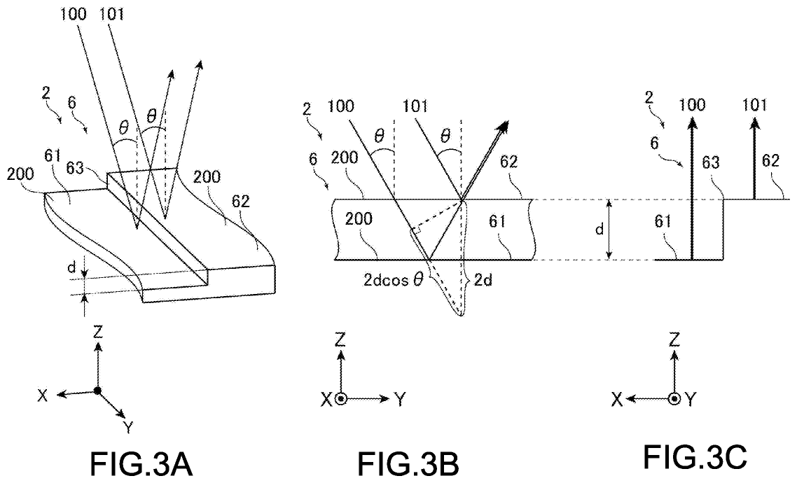

FIGS. 3A to 3C are schematic diagrams illustrating the optical encoder 1. Specifically, FIG. 3A is a perspective view showing the step portion 6 in the scale 2. FIG. 3B is a view of the step portion 6 as viewed from the X-direction. FIG. 3C is a view of the step portion 6 as viewed from the Y-direction.

Hereinafter, the principle of forming the darkest portion with high-contrast by irradiating the step portion 6 with the light from the light source 4a in an inclined manner, while suppressing the deterioration of the contrast of the contrast pattern due to a change in the phase difference between the two light waves will be described. In the following drawings, for convenience of explanation, the light path of the light from the light source 4a may be represented by a solid line arrow. Further, “irradiating the step portion 6 with the light from the light source 4a in an inclined manner” means that the light source 4a irradiates the step portion 6 with light at an angle from the direction perpendicular to the scale surface 200 along the Y-Z plane toward the scale surface 200.

As shown in FIG. 3A, the light source 4a irradiates toward the scale surface 200 the light parallel to the Y-Z plane along the Y-Z plane, at an angle θ from the direction perpendicular to the scale surface 200. At this time, the length of the connection surface 63 from the lower portion 61 to the upper portion 62, which is the height in the Z direction from the lower portion 61 to the upper portion 62, is a distance d. Further, the light from the light source 4a through the step portion 6 includes a first light 100 reflected at the lower portion 61 and a second light 101 reflected at the upper portion 62. Since the first light 100 and the second light 101 respectively pass through the lower portion 61 and the upper portion 62 of the step portion 6, velocity of the one of the lights becomes slower. Therefore, a phase difference occurs between the first light 100 and the second light 101.

Here, as described above, the contrast of the contrast pattern by the first light 100 and the second light 101 is varied by the phase difference. Further, the phase difference is varied due to change in the difference between the optical path length of the first light 101 and the optical path length of the second light, change in the wavelength λ of the light from light source 4a, and change in the distance d of the connection surface 63.

As shown in FIG. 3B, when the light source 4a irradiates light at an angle θ along the Y-Z plane, the difference in the respective optical path lengths of the first light 100 and the second light 101 can be expressed by 2d×cos θ, and the phase difference between the first light 100 and the second light 101 is expressed by Equation (1).

2π×(2d×cos θ)÷λ=2π×(2d/λ)×cos θ (1)

The factor of the variation in the phase difference between the first light 100 and the second light 101 is 2d/λ in the right-hand equation of the Equation (1). Then, as the angle θ of the irradiation of the light by the light source 4a increases, the value of cos θ is reduced. That is, by increasing the angle θ of the irradiation by the light source 4a, the value of cos θ is reduced, accordingly, the value of 2d/λ which is the factor of the variation of the phase difference is also reduced. Therefore, even if the distance d in the connection surface 63 and the wavelength λ of the light from the light source 4a are changed, since the light source 4a irradiates the step portion with light at an angle θ, it is possible to reduce the influence on the phase difference.

Then, as shown in FIG. 3C, the first light 100 is reflected by the lower portion 61 and the second light 101 is reflected by the upper portion 62. Thereby, the interference at the light receiving surface 50 (see FIG. 1) of the light receiving unit 5a occurs, and the darkest portion with high contrast is generated in the portion corresponding to the connection surface 63 in the contrast pattern.

The optical encoder 1 first, causes the light source 4a to emit light to irradiate parallel light beam toward the scale surface 200, and causes the scale 2 and the head 3 to move relatively. Next, after the relative movement of the scale 2 and the head 3, parallel light is irradiated to the step portion 6. At this time, the origin calculating unit 71 continues to observe the output level of the signal due to the interfering light generated on the light receiving surface 50 obtained through the light receiving unit 5a. When parallel light is irradiated to the step portion 6, the light receiving unit 5a detects the darkest portion with the highest contrast in the contrast pattern. The origin calculation unit 71 identifies the position of the darkest portion detected by the light receiving unit 5a, and calculates the position on the identified darkest portion as the origin position that is a reference of the relative movement between the scale 2 and the head 3.

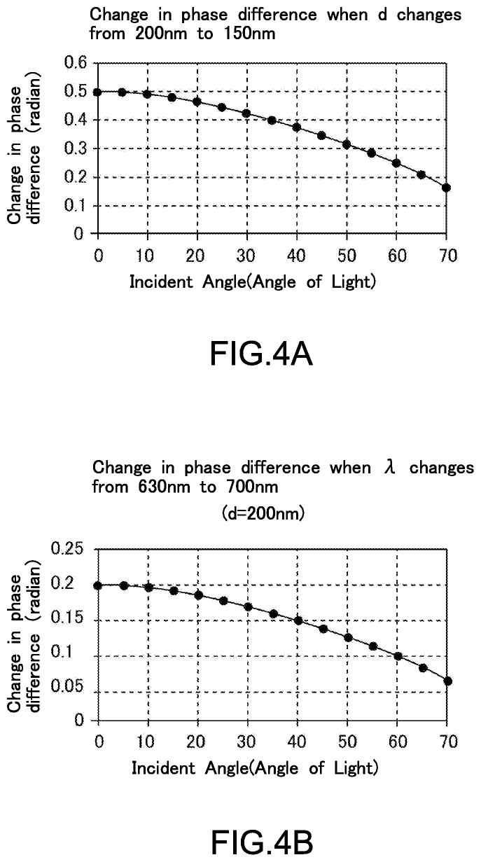

FIGS. 4A and 4B are graphs showing changes in the phase difference between two light waves in the optical encoder 1. Specifically, FIG. 4A is a graph showing change in the phase difference when the distance d in the connection surface 63 changes with the vertical axis indicating the change in the phase difference and the horizontal axis indicating an incident angle (an angle of light). FIG. 4B is a graph showing change in the phase difference when the wavelength λ of the light from the light source 4a changes with the vertical axis indicating the change in the phase difference and the horizontal axis indicating the incident angle (the angle of light).

In both the graphs of FIGS. 4A and 4B, when the angle θ of the inclination of the light from the light source 4a is 30 degrees, the effect of the contrast deterioration of the contrast pattern due to the phase difference is reduced to 86.6% as compared with the case of irradiating the light from the direction perpendicular to the scale surface 200. Further, when the angle θ is 60 degrees, as compared with the case of irradiating from a direction perpendicular to the scale surface 200, the effect of the deterioration of the contrast of the contrast pattern due to the phase difference is reduced to 50%. Therefore, when designing the optical encoder 1, it is preferable that the angle θ of the irradiation of the light source 4a from 30 degrees to 45 degrees. Incidentally, the angle θ of the irradiation of the light source 4a is not intended to be limited to 30 degree to 45 degrees, it may be designed at any angle.

According to this embodiment, the following functions and effects can be achieved.

(1) By irradiating the step portion 6 with the light in inclined manner with respect to a direction perpendicular to the scale surface 200, the light source 4a can reduce the effect on the phase difference between the first light 100 and the second light 101, even if there are manufacturing error of the distance d of the connection surface 63, which is the thickness of the step portion 6, deformation of the scale 2 due to environmental changes, or change in the wavelength λ of the light of the light source 4a. The origin calculating unit 71 identifies the darkest portion from the contrast pattern with high contrast caused by the interference light with suppressed fluctuation of the phase difference, and calculates the identified darkest portion as the origin position.

Therefore, the optical encoder 1 can suppress the deterioration of the contrast due to the fluctuation of the phase difference, and detect the origin position with high accuracy.

(2) By irradiating the step portion 6 with light from a direction inclined along the connection surface 63, the light source 4a can suppress the movement of the position of the darkest portion caused by the hitting state of light from any direction to the step portion 6, and cause the darkest portion at the position corresponding to the connection surface 63. Therefore, the optical encoder 1 can suppress the deviation of the origin position due to the irradiation angle of light to the step portion 6.
(3) By irradiating the step portion with light in the direction inclined along the connection surface 63, the light source 4a can suppress the movement of the position of the darkest portion, and it is possible to easily design such as the arrangement of the light source 4a that causes the darkest portion at a position corresponding to the connection surface 63.
(4) By connection surface 63 is formed in the Y-Z plane perpendicular to the measurement direction, the darkest portion is formed in a straight line at a position corresponding to the connection surface 63. Therefore, the optical encoder 1 can generate the origin position with high accuracy.
(5) Since the scale pattern 20 and the step portion 6 reflect the light from the light source 4 toward the light receiving unit 5, the distance d of the connection surface 63 which is the thickness of the step portion 6 can be formed thinner as compared with the case where the scale transmits light. Therefore, the optical encoder 1 can reduce the cost and miniaturize as compared to the case of a transmission type.

### Second Embodiment

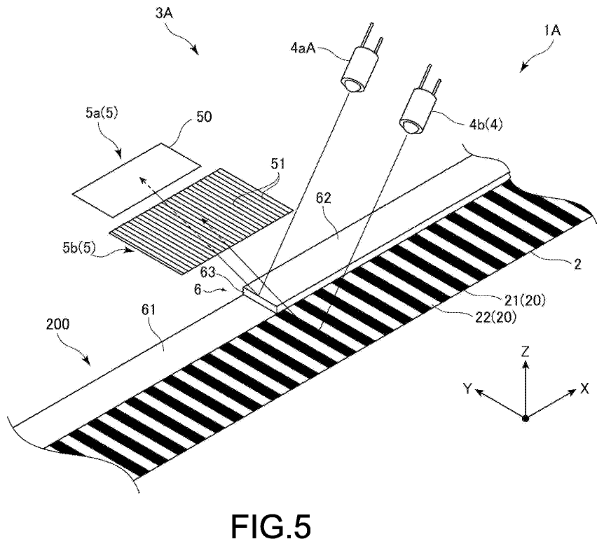

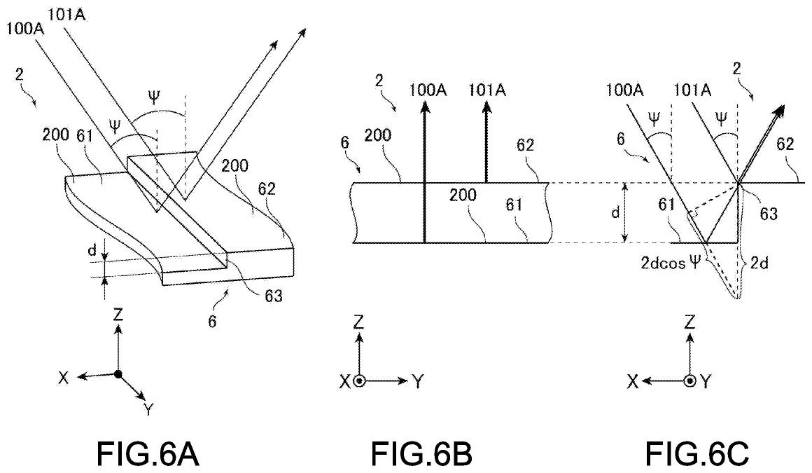

In the following, the second embodiment of the present invention will be described on the basis of FIG. 5 to FIG. 6C. In the following description, portions already described are denoted by the same reference numerals, and description thereof is omitted.

FIG. 5 is a perspective view illustrating an optical encoder 1A according to the second embodiment. FIGS. 6A to 6C are schematic diagrams illustrating the optical encoder 1A. Specifically, FIG. 6A is a perspective view showing the step portion 6 in the scale 2. FIG. 6B is a view of the step portion 6 as viewed from the X-direction. FIG. 6C is a view of the step portion 6 as viewed from the Y-direction.

In the first embodiment, the light source 4a irradiates the step portion 6 with the light in a direction inclined along the connection surface 63 formed in the Y-Z plane perpendicular to the measurement direction.

In the second embodiment, as shown in from FIG. 5 to FIG. 6C, a light source 4aA in a head 3A is different from the light source 4a of the first embodiment in that the light source 4aA irradiates the step portion 6 with light from a direction inclined along the X-Z plane perpendicular to the scale surface 200 and parallel to the measurement direction.

As shown in FIG. 6A, the light source 4aA irradiates the light inclined at an angle Ψ along the X-Z plane, in parallel to the X-Z plane. As shown in FIG. 6B, when the light source 4aA irradiates light at an angle Ψ along the X-Z plane, the difference in the respective optical path lengths of the first light 100A and the second light 101A can be expressed by 2d×cos Ψ, and the phase difference is expressed by Equation (2).

2π×(2d×cos Ψ)÷λ=2π×(2d/λ)×cos Ψ (2)

Similar to the optical encoder 1 of the first embodiment, the factor of the variation in the phase difference is 2d/λ in the right-hand equation of the Equation (2). By increasing the angle Ψ of the irradiation by the light source 4aA, the value of cos Ψ is reduced, accordingly, the value of 2d/λ which is the factor of the variation of the phase difference is also reduced. Therefore, even if the distance d in the connection surface 63 and the wavelength λ of the light from the light source 4aA are changed, since the light source 4aA irradiates the step portion with light at an angle Ψ, it is possible to reduce the influence on the phase difference. Then, as shown in FIG. 6C, the first light 100A is reflected by the lower portion 61 and the second light 101A is reflected by the upper portion 62. Thereby, the interference at the light receiving surface 50 (see FIG. 1) of the light receiving unit 5a occurs, and the darkest portion with high-contrast is generated in the portion corresponding to the connection surface 63 in the contrast pattern.

In such a second embodiment, it is also possible to acquire functions and effects similar to those in (1), (4), and (5) in the first embodiment. In addition, the following function and effect can be acquired.

(6) The optical encoder 1A can improve the degree of freedom in designing, since the darkest portion can be generated based on the light in which the deterioration of the contrast due to the change in the phase difference is suppressed, even the light source 4aA irradiates the step portion 6 with the light inclined along the X-Z plane perpendicular to the scale surface 200 and parallel to the measurement direction.

### Third Embodiment

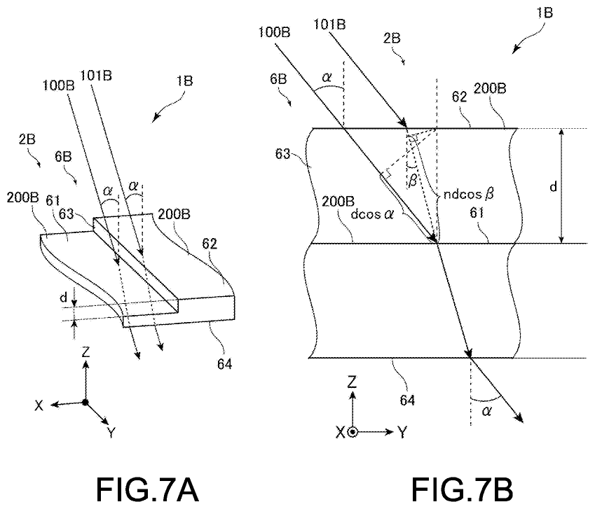

In the following, the third embodiment of the present invention will be described on the basis of FIGS. 7A and 7B. In the following description, portions already described are denoted by the same reference numerals, and description thereof is omitted.

FIGS. 7A and 7B are schematic diagrams illustrating an optical encoder according to the third embodiment. Specifically, FIG. 7A is a perspective view showing the step portion 6B in the scale 2B. FIG. 7B is a view of the step portion 6B as viewed from the X direction.

In the first embodiment, the step portion 6 in scale 2 reflects the light from the light source 4a, and the light receiving unit 5a receives the light reflected by the step portion 6.

As shown in FIGS. 7A and 7B, the third embodiment is different from the first embodiment in that the step portion 6B in the scale 2B transmits light from the light source 4a (see FIG. 1), and that the light receiving unit 5a (not shown) receives the light transmitted through the step portion 6B.

As shown in FIG. 7A, the light source 4a (see FIG. 1) irradiates toward the scale surface 200B the light parallel to the Y-Z plane along the Y-Z plane, at an angle α toward the scale surface 200B from the direction perpendicular to the scale surface 200B. Then, as shown in FIG. 7B, the light irradiated to the step portion 6B is transmitted through the scale 2B, and the light is emitted at an angle α from the scale surface 64 opposite to the scale surface 200B provided with the step portion 6B.

When the light source 4a irradiates light at an angle α along the Y-Z plane, the difference in optical path length between the first light 100B and the second light 101B can be expressed by ndcos β-d cos α on the condition that the refractive index of the scale 2B is n and the refractive index n is n=sin α/sin β.

In the optical encoder 1B according to the third embodiment, by increasing the angle α of the irradiation by the light source 4a, the value of cos α is reduced, accordingly, the value of 2d/λ which is the factor of the variation of the phase difference is also reduced as in the optical encoder 1 according to the first embodiment. Therefore, even if the distance d in the connection surface 63 and the wavelength λ of the light from the light source 4a are changed, since the light source 4a irradiates the step portion with light at an angle α, it is possible to reduce the influence on the phase difference.

In such a third embodiment, it is also possible to acquire functions and effects similar to those in (1) to (4) in the first embodiment. In addition, the following action and effect can be acquired.

(7) The optical encoder 1B can improve the degree of freedom in designing, since the darkest portion can be generated based on the light in which the deterioration of the contrast due to the change in the phase difference is suppressed, even the step portion 6 transmit the light from the light source 4a.

### Fourth Embodiment

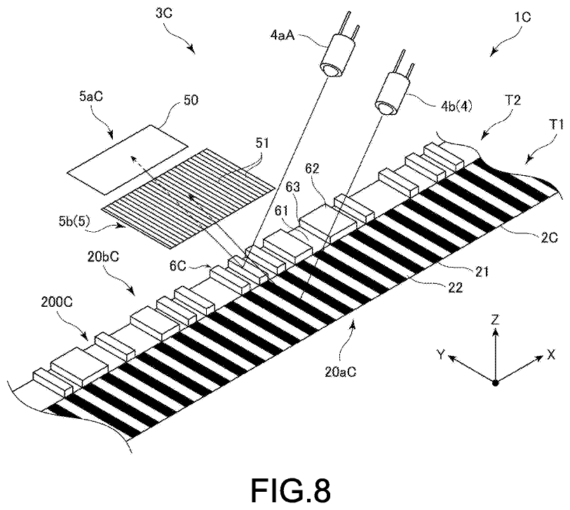

In the following, the fourth embodiment of the present invention will be described on the basis of FIG. 8. In the following description, portions already described are denoted by the same reference numerals, and description thereof is omitted.

FIG. 8 is a perspective view illustrating an optical encoder according to the fourth embodiment.

In the above explained respective embodiments, by light being irradiated from the light source (4a, 4aA), the step portion 6 causes interference light having the contrast pattern on the light receiving surface 50 of the light receiving unit 5a, and the darkest portion which is the darkest pattern in the contrast pattern was formed at a position corresponding to the origin position.

As shown in FIG. 8, the fourth embodiment is different from the above explained respective embodiments in that a step portion 6C in a scale 2C is formed on a scale surface 200C so as the contrast pattern on a light receiving unit 5aC of a head 3C to be pseudo-random.

Here, as a detection method of the relative movement amount of the scale and the head in the optical encoder, incremental method (hereinafter, sometimes referred to as INC method) such as explained in the respective embodiment and an absolute method (hereinafter, sometimes referred to as ABS method) are known.

The INC method is a method of detecting a relative position by continuously detecting an incremental pattern (hereinafter, sometimes referred to as an INC pattern) which is a scale pattern arranged at a constant pitch on the scale and counting up or down the number of graduations of the detected INC pattern.

The ABS method, is a method of detecting an absolute position by detecting an absolute pattern (hereinafter, sometimes referred to as ABS pattern) which is a scale pattern graduation is randomly arranged on the scale at an appropriate timing and analyzing the ABS pattern.

As the ABS method, there is a method in which the scale of the ABS pattern is arranged based on an M-sequence code which is a two-leveled pseudo random code over the entire length of the scale in the optical encoder, and the absolute value is determined from the ABS pattern received by the light receiving unit. Specifically, for example, the absolute position is calculated by analyzing the pseudo-random code which is a combination of “1” and “0” of the signal consisting of a plurality of “1” and “0”. The pseudo-random code includes an M sequence code, a Gold sequence code, and a Barker sequence code depending on the analysis method and the type of code.

In the fourth embodiment, the step portion 6C in the optical encoder 1C is arranged in the scale surface 200C so as to represent the absolute position according to the pseudo-random code. The contrast pattern through the step portion 6C is received by the light receiving unit 5aC as a signal consisting of a plurality of “1” and “0”. The combination of “1” and “0” in the contrast pattern is different at each position of one track. Therefore, the optical encoder 1C can calculate the absolute position of the head with respect to the scale by analyzing the combinations of “1” and “0” in the signals consisting of a plurality of “1” and “0”, and specify a predetermined absolute position as the origin position.

In addition, the detection accuracy can be improved by using both the INC method and the ABS method in combination. This is because, in the case where only the ABS method is used, the number of graduations constituting the scale pattern is small compared with the INC pattern, and therefore, the detection accuracy may not be as good as the INC method.

The scale 2C of the optical encoder 1C is a double-track type in which an incremental track T1 (hereinafter, sometimes referred to as an INC track) including the INC pattern 20aC and an absolute track T2 (hereinafter, sometimes referred to as an ABS track) including the ABS pattern 20bC are provided. The optical encoder 1C irradiates light from the light sources (4aA, 4b) toward the INC track T1 and ABS track T2. The light receiving units (5aC, 5b) receive the light through each track T1, T2 to detect the INC pattern 20aC and ABS pattern 20bC. Then the optical encoder calculates the position information based on the respective patterns (20aC, 20bC).

In such a fourth embodiment, it is also possible to acquire functions and effects similar to those in (1) to (4) in the first embodiment. In addition, the following action and effect can be acquired.

(8) By the step portion being formed on the scale surface 200C so that the contrast pattern is pseudo-random, the difference in the brightness of the contrast pattern in the light receiving unit 5aC can be made remarkable. Consequently, the optical encoder 1C can detect the origin position with high accuracy and easily even if there is a cause of deterioration of the contrast due to the fluctuation of the phase difference.

### MODIFICATION OF EMBODIMENT

Note that the present invention is not limited to each of the above embodiments and modification, improvement, and the like within the spirit and the scope of the present invention are included.

For example, though in the embodiments described above, the optical encoder (1, 1A-1C) is used in an linear scale as a measuring device, the optical encoder may be used in other measuring device such as a dial gauge (test indicator) or a micrometer. That is, the optical encoder is not particularly limited with respect to the type and method of the measuring instrument used, and can be used in other measuring instruments and the like. The equipment on which the optical encoder of the present invention is mounted is not particularly limited. The optical encoder may be used in a device other than a measurement device such as a sensor.

In the embodiments described above, the optical encoder (1, 1A-1C) was a linear encoder, but may be a rotary encoder. Further, in each of the embodiments described above, the calculating unit 7 is a microcomputer or the like, but may not be a microcomputer. The calculating unit 7 may be an externally connected personal computer or the like, and may be configured by any kind of means as long as the calculating unit can perform calculation.

In each of the embodiments described above, though the light source 4 is provided with the light source (4a, 4aA) used for detecting the home position and the light source 4b used for detecting the relative movement of the scale 2 and the head 3, the light source (4a, 4aA) and the light source 4b may be the same light source. Further, the light receiving unit 5 is provided with a plurality of light receiving units (5a, 5aC, 5b) corresponding to the light sources, the light receiving unit may be a single light receiving unit. In short, the light source only needs to be able to irradiate light to the scale, and the light receiving unit only needs to be able to receive light from the light source through the scale.

In each of the embodiments except for the third embodiment, the scale pattern (20, 20aC, 20bC) reflects light, but the scale pattern may transmit light. In this case, the scale may include scale pattern (20, 20aC, 20bC) reflecting light and a step portion (6, 6C) as in the scale (2, 2C) of the first embodiment, the second embodiment, and the fourth embodiment. The scale may include the scale pattern and the step portion 6B transmitting light as in the scale 2B of the third embodiment. Alternatively, one of the scale pattern and the step portion may be configured to reflect light, and the other may be configured to transmit light, and combine them. In short, the step portion generates interference light having a contrast pattern when light is irradiated from the light source, and generate the darkest portion with the highest contrast in the contrast pattern.

In the first embodiment, the light source 4a irradiates the step portion 6 with the light in a direction inclined along the connection surface 63 formed in the Y-Z plane perpendicular to the measurement direction. In the second embodiment, the light source 4aA irradiates the step portion with the light in a direction inclined along the X-Z plane parallel to the measurement direction. The mode of irradiation by the light source is not limited to these, and the light may be irradiated in any manner as long as the light can be irradiated to the step portion in an inclined manner with respect to the direction perpendicular to the scale surface.

In each of the embodiments described above, the scale pattern (20, 20aC) is incremental pattern, but may be absolute patterns or other patterns, and the type of patterns is not limited.

In each of the embodiments described above, the step portion (6, 6B) is provided side by side with the scale pattern 20 in the scale (2, 2B), but the step portion may not be provided side by side with the scale pattern. The step portion can be provided at any position such as an end of the scale or an intermediate portion of the scale as long as it is provided at the origin position.

In each of the embodiments described above, though the connection surface 63 is formed on the plane perpendicular to the measurement direction, the connection surface may not be formed on the plane perpendicular to the measurement direction. For example, the connection surface may have an inclination, or may be formed in a curved surface shape or a wave shape. In short, the connection surface only needs to connect the low position and the upper portion. The step portion may not have the connection surface. The step portion may be formed in any manner, as long as it generates interference light having a contrast pattern on the light receiving surface when light is irradiated from the light source, and generate the dark area with the highest contrast in the contrast pattern.

### INDUSTRIAL APPLICABILITY

As described above, the present invention can be suitably used for the optical encoder.

What is claimed is:

1. An optical encoder comprising:
a scale having a scale pattern provided along the measurement direction;
a head that opposes to the scale and moves relatively to the scale along the measurement direction; and
a calculating unit for performing a calculation based on the relative movement of the scale and the head,
wherein:
the head comprises a light source irradiating the scale with light and a light receiving unit having a light receiving surface for receiving light from the light source through the scale;
the scale includes a step portion formed as a step with a height difference in the scale surface facing at least one of the light source or the light receiving unit;
the step portion generates interference light having a contrast pattern on the light receiving surface when light is irradiated from the light source, and generate a darkest portion with the highest contrast in the contrast pattern;
the light source irradiates the step portion with light from a direction inclined with respect to a direction perpendicular to the scale surface; and
the calculating unit includes an origin calculating unit that identifies the darkest portion from the contrast pattern in the interference light received by the light receiving unit through the step portion and calculates the identified darkest portion as the origin position that is a reference of the relative movement between the scale and the head.

2. The optical encoder according to claim 1, wherein the light source irradiates the step portion with the light from a direction inclined along a plane perpendicular to the measurement direction.

3. The optical encoder according to claim 1, wherein the step portion includes a lower portion provided at a low position in the scale surface, an upper portion provided at a high position in the scale surface, and a connection surface for connecting the lower portion and the upper portion, and
the light source irradiates the step portion with the light from a direction inclined along the connection surface.

4. The optical encoder according to claim 3, wherein the connection surface is formed in a plane perpendicular to the measurement direction.

5. The optical encoder according to claim 1, wherein the step portion is formed on the scale surface so that the contrast pattern is pseudo-random.

6. The optical encoder according to claim 1, wherein the step portion reflects the light from the light source toward the light receiving unit.
